(19) United States
(12) Patent Application Publication
(10) Pub. No.: US 2015/0378533 A1
(43) Pub. Date: Dec. 31, 2015

(54) GEOSOCIAL NETWORK FOR BOOK READING AND USER INTERFACE THEREOF

(71) Applicant: Kobo Incorporated, Toronto (CA)

(72) Inventor: Benjamin LANDAU, Toronto (CA)

(21) Appl. No.: 14/317,208

(22) Filed: Jun. 27, 2014

(51) Int. Cl. G06F 3/0483; H04L 29/08; G06F 3/0484

(52) U.S. Cl. CPC G06F 3/0483; G06F 3/04842; H04L 67/18

(57) ABSTRACT

System and method for facilitating location-based social networking among book readers. An electronic reading device installed with a networking application program is allowed to submit a request for discovering compatible readers within a distance from its current location. Compatible readers can be automatically located based on the reading devices associated therewith and based on compatibilities of the reading profiles. The information of the discovered compatible readers can be presented to the requesting reader and allow the requesting reader to initiate an on-line communication with a selected compatible reader. Moreover, a reader can purchase books listed in another reader's reading profile.

### TECHNICAL FIELD

The present disclosure relates generally to the field of geosocial networks, and, more specifically, to the field of geosocial networks and mobile computing devices.

### BACKGROUND

The use of electronic devices to read books, newspapers and magazines in electronic form has become increasingly commonplace due to the numerous significant advantages afforded by such devices over conventional paper print. For example, compared to paper print, an electronic reading device can hold greater amounts of information, allow immediate access to new books, personalize the reading display format, and facilitate night reading, etc. Electronic reading devices can be implemented as dedicated reading devices, e.g., e-readers, as well as general-purpose electronic devices, such as desktop, laptop and hand-held computers.

A book lover often feels proud of what he or she is reading and desires to share thoughts on the current readings with others. On-line reading communities hosted by various entities (e.g., book stores, universities, social networks, and reading clubs) provide convenient forums for readers to communicate and share their reading experiences on the Internet. However, many readers still prefer meeting others with the common interests in person, e.g., for discussions on the books or any other social interest.

In many settings, a book reader can be surrounded by many strangers who have a common interest in books in general or in particular books, e.g., at an airport, a coffee shop, a restaurant, a library, or a park, etc. Though unbeknownst to the book reader, some strangers may be available and willing to have an on-line or in-person conversation about books as well, especially a current reading. However, there lacks a mechanism allowing the book reader to instantly find another reader nearby who has similar reading interests.

### SUMMARY OF THE INVENTION

Therefore, it would be advantageous to provide a mechanism and method to facilitate matching and communication among mutually interested book readers.

Embodiments of the present disclosure employ a computer implemented method of providing a social networking platform for book readers to dynamically discover compatible readers based on their book reading profiles and geolocations, and thereafter initiate instant personal contacts. A mobile smart phone or e-reader device can be used as a platform. A registered member of a virtual reading community can create personal profiles identifying a selection of books. The selection of books may be input by the member or automatically generated based on a member's reading library or history. The current reading may be automatically incorporated into the set of books of the personal profile.

A mobile electronic reading device (e.g., an e-reader) used by the member can send a discovery request to a server for discovering readers with similar reading interests (or the compatible readers). Based on the compatibility between the personal profiles of the requesting reader and those of other currently available readers, other compatible readers within a specified distance from the requesting reader can be identified automatically. The specified distance can be set to a walking distance if an instant in-personal meeting is desired. Thereby a reader can conveniently locate and establish contact with another reader having similar reading interests. Any distance can be used.

Through a graphical user interface (GUI), relevant information about the compatible readers is presented to the requesting member. The GUI allows the requesting member to initiate a real-time communication with a selected compatible reader. Further, the GUI enables a requesting member to purchase books listed in the profiles of the selected compatible readers. Privacy settings of the compatible readers dictate what relevant information can be displayed concerting their profiles.

According to one embodiment of the present disclosure, a computer implemented method comprises: (1) rendering an on-screen GUI for display on a display device coupled to a first computing device, wherein the on-screen GUI is configured to present content of electronic books; (2) receiving user input via the on-screen GUI to configure a first personal profile of a user of the first computing device, wherein the first personal profile identifies a first selection of books; (3) sending indications representing a first geolocation of the first computing device to a server; (4) sending a request to a server for discovering compatible readers within a distance from the first geolocation; (5) receiving personal profiles of discovered compatible readers from the server, wherein each personal profile comprises a respective selection of books associated with a corresponding discovered compatible reader, wherein the discovered compatible readers are discovered based on geolocations of computing devices associated with the discovered compatible readers and further based on and relatedness between the first selection of books and respective selections of books of the discovered compatible readers; (6) receiving the geolocations of the computing devices from the server; and (7) displaying a plurality of visual objects on the on-screen GUI, wherein the plurality of visual objects represent the discovered compatible readers.

In one embodiment, the user and the discovered compatible readers are registered members of a book reading community that hosts the server or website. The on-screen GUI may be configured to: receive a user interaction with a visual object of the plurality of visual objects, wherein the visual object represents a first discovered compatible reader; display a personal profile of the first discovered compatible reader, wherein the personal profile comprises a photo and identifications of a second selection of books, book genres and authors preferred by the first discovered compatible reader; and display a plurality of clickable objects associated with the second selection of books respectively, wherein a user interaction with a clickable object by the user is operable to open a webpage configured to facilitate an on-line purchase transaction of a corresponding book.

The first selection of books may comprise a book currently being read on the first computing device. The second selection of books may comprise a book currently being read on a computing device used by the first discovered compatible readers.

The method may further comprise: receiving compatibility scores of the discovered compatible readers from the server, wherein each compatibility score is determined by comparing the first personal profile and a corresponding personal profile of a respective discovered compatible reader, and wherein the on-screen GUI is configured to present the compatibility scores.

The method may further comprise accessing a library of books stored in the computer device; automatically generating the first selection of books based on the library; and automatically sending the first personal profile to the server. The method may further comprise: sending a communication request for real-time communication with the first discovered compatible reader; and rendering an on-line chat interface on the display device of the first computing device, wherein the on-screen chat interface is configured to display messages exchanged between the user and the first discovered compatible reader.

According to another embodiment of the present disclosure, a computer implemented method comprises: (1) receiving a discovery request sent from a requesting device via a communication network, wherein the requesting device is associated with a requesting user; (2) determining a geolocation of the requesting device; (3) locating a set of computing devices associated with eligible users that are located within a distance from the geolocation; (4) comparing a personal profile of the requesting user and a personal profile of the eligible users of the set of computing devices, wherein each of the personal profiles comprises reading preferences of a corresponding user; (5) selecting compatible users from the eligible users based on the comparing; and (6) sending information on the compatible users to the requesting device, wherein the information comprises identities, personal profiles, compatible scores and geolocations.

According to another embodiment of the present disclosure, a system comprises a bus; a processor coupled to the bus; memory coupled to the processor via the bus and comprising instructions that, when executed by the processor, cause the system to perform a method of facilitating geosocial networking among book readers. The method comprises: (1) rendering an on-screen graphical user interface (GUI) for display on a display device coupled to a first computing device, the first computing device being associated with a first personal profile of a user of the first computing device, wherein the first personal profile identifies a first selection of books; (2) sending a request to a server for discovering compatible readers within a distance from a first geolocation of the computing device; (3) receiving personal profiles of discovered compatible readers from the server, wherein each personal profile comprises a respective selection of books associated with a corresponding discovered compatible reader, wherein the discovered compatible readers are discovered based on geolocations of computing devices associated with the discovered compatible readers and further based on relatedness between the first selection of books and the selections of books associated with the discovered compatible readers; (4) receiving the geolocations of discovered compatible readers from the server; and (5) displaying a plurality of visual objects on the on-screen GUI, wherein the plurality of visual objects represent the discovered compatible readers.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates an exemplary system of geosocial networking among book readers in accordance with an embodiment of the present disclosure.

FIG. 2 is a flow chart depicting a computer implemented method of discovering compatible readers within a distance in accordance with an embodiment of the present disclosure.

FIG. 3 is a flow chart depicting an exemplary computer implemented method of providing a geosocial networking platform for e-book readers in accordance with an embodiment of the present disclosure.

FIG. 4 is an exemplary on-screen GUI window configured to present the discovery results on a requesting device in accordance with an embodiment of the present disclosure.

FIG. 5 is an exemplary on-screen GUI window configured to present a personal profile of a compatible reader in accordance with an embodiment of the present disclosure.

FIG. 6 is a function block diagram showing the components of a geosocial networking manager program in accordance with an embodiment of the present disclosure.

FIG. 7 is a block diagram illustrating an exemplary electronic reading device installed with a reading experience program having a book reading geolocation networking feature in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Geosocial Network for Book Reading and User Interface Thereof

Overall, provided herein are system and method for facilitating location-based social networking among book readers. An electronic reading device (the requesting device) installed with an application program in accordance with the present disclosure can submit a request for discovering compatible readers within a distance from its current location. Compatible readers can be automatically located based on the reading devices associated with them and based on compatibilities of the reading profiles. The application program can present the information of the discovered compatible readers to the requesting reader and allow the requesting reader to initiate an on-line communication with a selected compatible reader. Moreover, a reader can purchase books listed in another reader's reading profile through the application program.

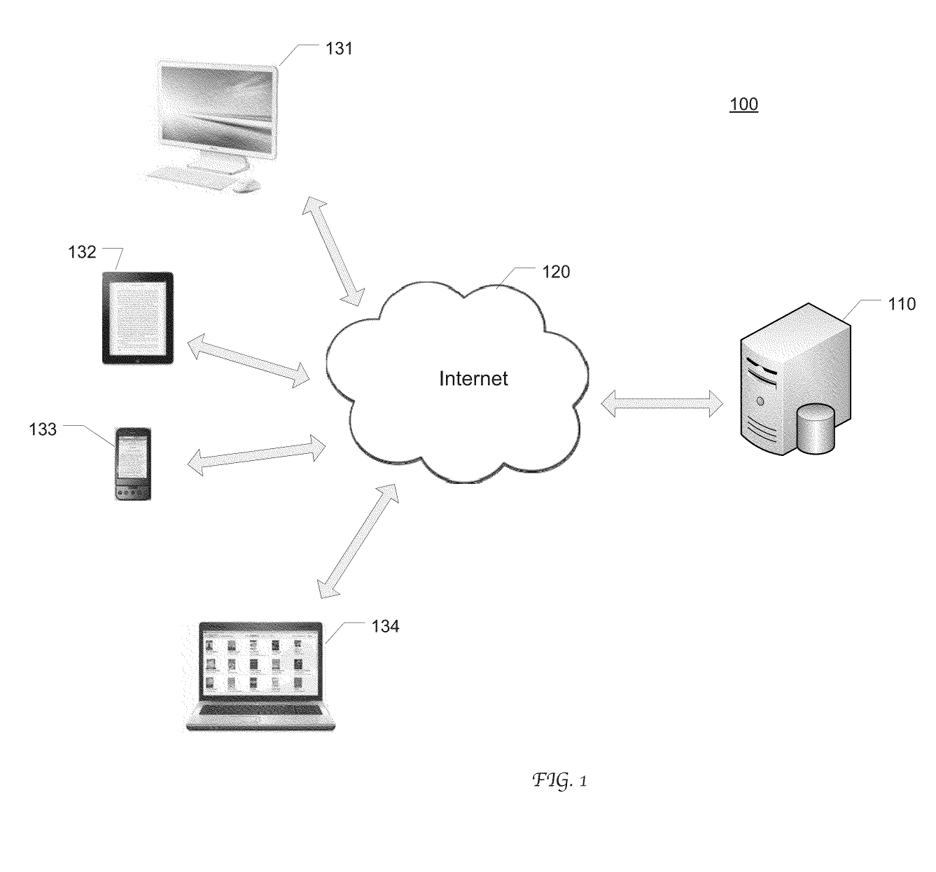

FIG. 1 illustrates an exemplary system 100 of geosocial networking among book readers in accordance with an embodiment of the present disclosure. The system includes a server 110 and client devices (or reading devices) 131-134 that are communicatively coupled to the Internet 120 by wire and wireless communication channels. For example, the server 110 may be hosted by an on-line book store, a book club, a book webpage, an education institution, or a company, etc. The server 110 is installed with a geosocial networking managing program, as will be described in greater detail below. The client devices are used by members affiliated with the hosting entity, and may include mobile smart phones and/or ebook reading devices, etc.

Each of the client devices 131-134 is installed with a geosocial networking application through which a member reader can establish a user account with the hosting entity and customize a personal profile pertaining to book reading. For example, the personal profile identifies the reader's preferred book genres, favorite books, recent readings, current readings, etc. The personal profile may be transmitted to the server 120 via the Internet 120 for storage. Alternatively, the server 120 may access the personal profile remotely from the client device when needed. Alternatively, the sever may automatically generate some or all of the profile of a particular reader based on the reader's history or library.

A client device (the “requesting device”, e.g., 131) can be a mobile electronic device and submit a networking request to the server 110 via the Internet 120, e.g., in response to a user instruction or periodically without any user prompt. The request is configurable by the requesting reader and specifies a distance from the geolocation of the requesting device. Upon receiving the request, the server 110 can determine the geolocation of the requesting device 131 and then locate other readers eligible for networking that are located from the requesting reader within the specified distance.

The server 110 can determine the geolocations of the client devices 131-134 by using the global positioning system (GPS) signals emitted therefrom. Alternatively, the server 110 can rely on the location information provided in the respective user accounts or personal profiles.

The eligible readers may be other registered members of the hosting entity or social networks, e.g., member of a book club, or a student or teacher of a school. As a reader may be affiliated with several hosting entities or social networks, the geosocial networking application may submit a networking request to more than one sever hosted by different social networks.

The server 110 can access the personal profiles of the requesting reader and each eligible reader (e.g., 132, 133, or 134) and determine their compatibility by comparing the personal profiles, as to be described in greater detail. Based on the compatibility, a number of compatible readers are selected from the eligible readers. At the same time, the server 110 may notify the requesting reader's interest in seeking a compatible reader and broadcast the personal profile of the requesting user to the eligible users, or alternatively to the discovered compatible readers. For example, an alert message may be displayed on the devices 132-133 once such a notice is received from the server 110.

The server 110 then communicates the discovery results with the requesting device 131, such as identifications, locations, compatible scores, and other information included in the personal profiles. The information received at the requesting device 131 is compiled by the geosocial networking application based on predetermined templates. For example, the geosocial networking application can render a graphical user interface (GUI) to display the photos of the compatible readers on a map to visually and/or graphically present the locations of discovered compatible readers.

The requesting reader can further submit a communication request to the sever 110 to contact a selected compatible reader (e.g., 132) by interacting with the GUI. The geosocial networking application on the requesting device renders a display of an on-line messaging interface allowing the requesting reader to send an initial message. Accordingly, the server 110 establishes a communication link between the devices 131 and 132. The server 110 can forward the communication invitation, including the initial message and the personal profile of the requesting reader, to the device 132. The selected compatible reader can choose whether to accept or reject the invitation.

Once an invitation is accepted, the server 110 may continue to act as a communication intermediary between the device 131 and device 132. For example, the two devices 131 and 132 can communicate in real time through the server in a server-client mode. In some other embodiment, the two devices 131 can establish a peer-to-peer communication channel across the network 120.

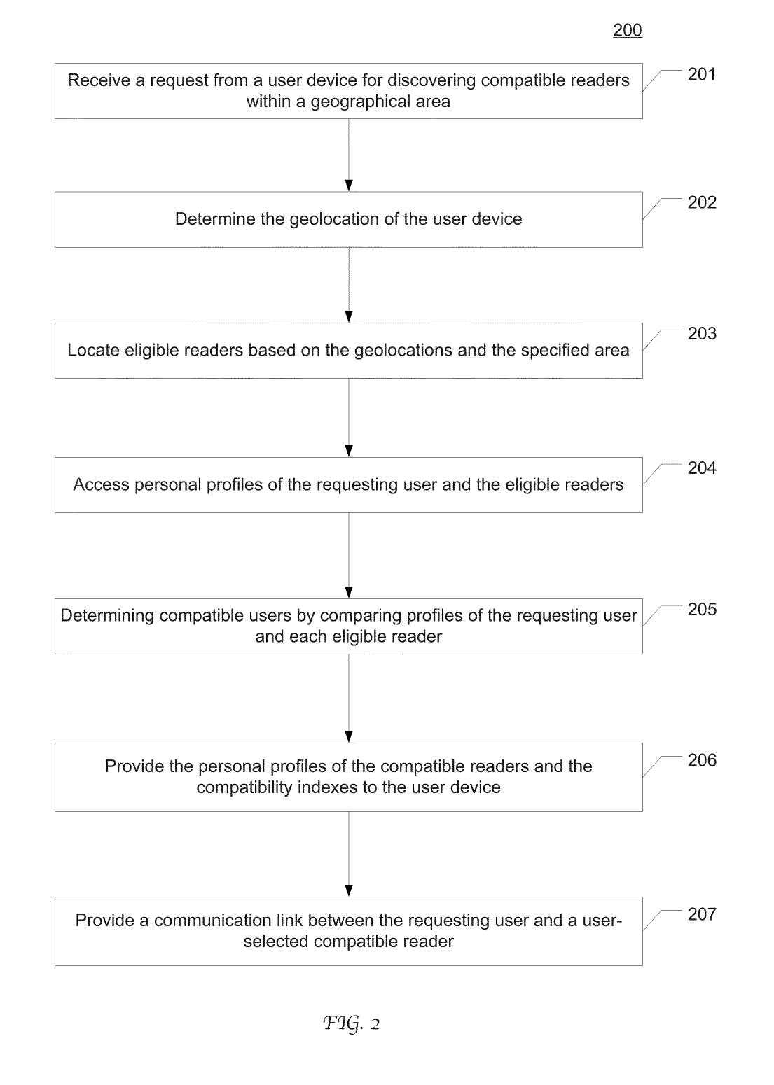

FIG. 2 is a flow chart depicting a computer implemented method 200 of discovering compatible readers within a given distance in accordance with an embodiment of the present disclosure. Method 200 can be implemented in a geosocial networking management program installed in a server, e.g., 110 in FIG. 1. At 201, a request is received from a client device for discovering compatible readers within a geographical area. It will be appreciated that the present disclosure is not limited to a geographical area of any range. The request may directly specify a distance (e.g., 500 ft or 10 miles) or an address covering a geographical area (e.g., the campus of a university, or the particular building). At 202, geolocation of the user device is determined based on its GPS signal or by accessing a registered location of the user or the user device. The distance may also be automatically determined based on the amount of users in the area.

At 203, eligible readers are located based on the geolocations and the specified geographical area. The eligible readers may be registered members of the hosting entity, e.g., member of a book club, or a student or teacher of a school. As a reader may be affiliated with several hosting entities or social networks, the geosocial networking application may submit a networking request to more than one severs hosted by different social networks.

The geosocial networking application may allow a requesting user to specify a set of screening criteria in the networking request to narrow down eligible readers in addition to the geographical requirement. Moreover, a reader can opt out of being discoverable by other readers through a privacy setting in the application.

At 204, the personal profiles of the requesting reader and the eligible readers are accessed from a database managed by the server or from respective client devices. Each personal profile may include brief biographical information about the reader (e.g., gender, age, education, and hobby) and a list books. The list of books may include books selected by the reader (e.g., a reader's favorite books), and/or automatically generated based on the reader's reading and/or purchase history. The automatically generated list may include the current readings, the most recent readings, the finished readings, and/or the repeated readings, etc.

If the requesting reader has not yet set up a personal profile that is accessible to the server 110, a message can be delivered to the requesting device 131 that suggests to him or her to create a personal profile for seeking compatible readers.

In some embodiments, a personal profile (either for a requesting reader or an eligible reader) can be generated automatically based on available personal information submitted to the server 110 earlier and the reader's reading history. For example, the one or more current readings can be automatically added in the personal profile. An automatically generated personal profile can also be updated by the reader before being published.

At 205, based on the compatibility indexes derived from personal profile comparisons, compatible readers are selected from the eligible readers that are located in 203. The present disclosure is not limited to any specific method or process of determining the compatibility between two readers. For example, a similarity score may be derived for each attribute in the personal files based on any suitable theoretical or empirical model. The similarity scores are then weighted and accumulated into a single index which indicates a comprehensive compatibility between two personal profiles.

Relatedness between the identified sets of book can be emphasized in determining a comprehensive compatibility index. Various techniques that are well known in the art can be used to determine relatedness or similarity between books or between sets of books for purposes of practicing the present disclosure. The relatedness determination can be based on book genres, authors, subject matters, titles, key terms, text-content and so on.

Further, a list of books may have different significance in their roles in determining a compatible reader. For example, recent readings are given more weight than old readings. For example, if the requesting user's current reading is also found to be a current reading of an eligible reader, a relatively large weight factor can be multiplied with the similarity score. In some embodiments, given a current reading of the requesting user, the server can access a personal library of an eligible reader to search for books that match the current reading.

At 206, the personal profiles of the compatible readers and the calculated compatible indexes are provided to the requesting reader's device. At 207, upon receiving an indication from the requesting reader for contacting a selected compatible reader, a communication link is established between their devices.

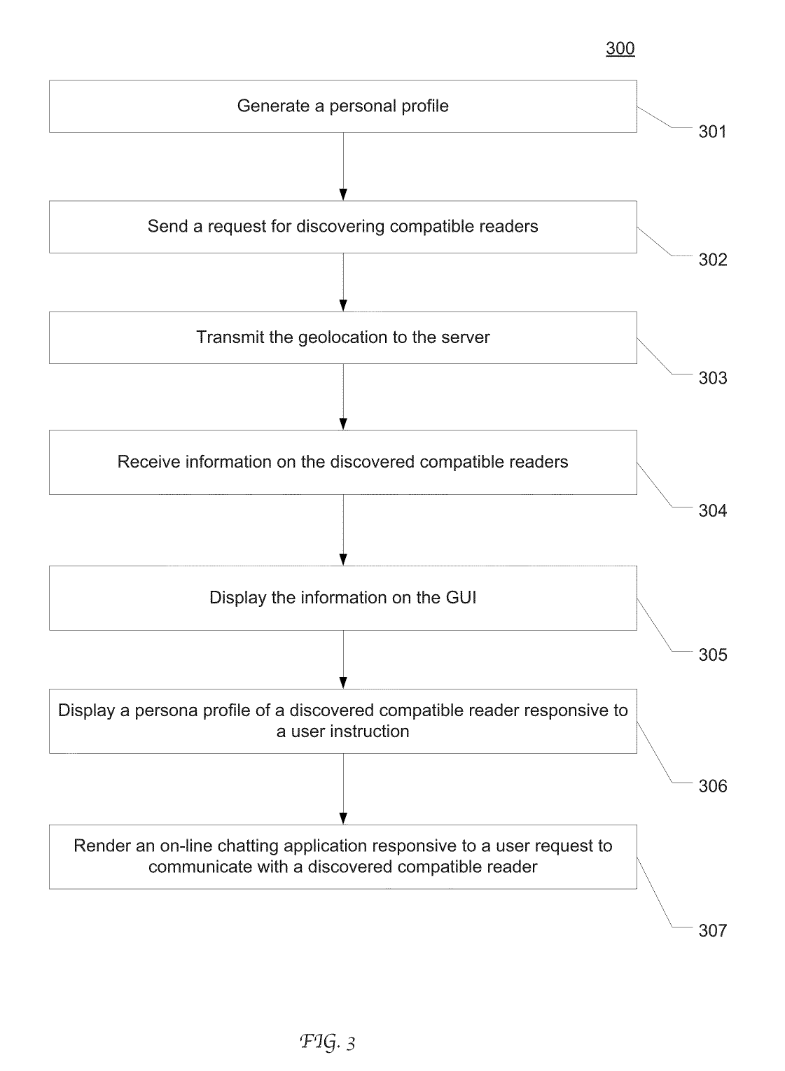

FIG. 3 is a flow chart depicting an exemplary computer implemented method 300 of providing a geosocial networking platform for e-book readers in accordance with an embodiment of the present disclosure. Method 300 can be implemented as an application program installed on a mobile electronic reading devices. At 301, a personal profile of a reader is generated or otherwise obtained. An on-screen graphical user interface (GUI) may be rendered to receive user input to configure the personal profile. The personal profile may contain any sort of information that a reader intends to publish on the Internet and thereby find other compatible readers.

At 302, a discovery request is transmitted from the reading device to a server for discovering compatible readers. For instance, a reader can submit the discovery request through the GUI rendered on the reading device. Alternatively, a discovery request may be generated automatically according to related user configurations. For instance, the GUI is configured to receive a user-specified time and make the discovery request submission a recurring calendar event. The GUI may also allow the user to specify a location so that an automatic discovery request can be submitted each time the reader's device is present at the location.

If the requesting user is affiliated with more than one book reading social network, the discovery request can be transmitted to the hosting servers of all or selected social networks. Therefore members affiliated with any of these social networks are potentially discoverable.

At 303 of FIG. 3, the GPS coordinates of the reading device and possibly a personal profile of the requesting reader are transmitted to a server. At 304, the information on the discovered compatible readers is received from the server. The information is processed and displayed in the GUI at 305. It will be appreciated that the present disclosure is not limited by the method of processing the information or the form of presenting the information. For instance, the identifications of the discovered compatible readers may be presented in a list within the GUI in order of distance from the requesting reader. The requesting user can select a name to read additional information on the reader. Thus, at 306, a personal profile of a selected compatible reader is presented to the requesting reader responsive to a user input.

At 307, upon receiving the requesting reader's request for contacting a selected compatible reader, an on-line communication interface is rendered in the GUI. It will be appreciated that various on-line communication techniques can be used for the requesting reader to initiate a contact with a selected compatible reader, or vice versa. For example, the requesting user can send a text message, a voice mail, an email, a video clip, and etc.

On the other end, the selected compatible reader receives the contact invitation and may choose to accept or reject the contact. The requesting user's personal profile can be made accessible to the compatible reader to facilitate an informative decision.

Once a contact is made, the two readers can converse about a particular book or subject matter of common interest, and recommend other books to the other through the GUI. The readers can also find each other for an in-personal chat that may include other located compatible readers. The requesting party can purchase a book in the other party's profile using the on-screen GUI.

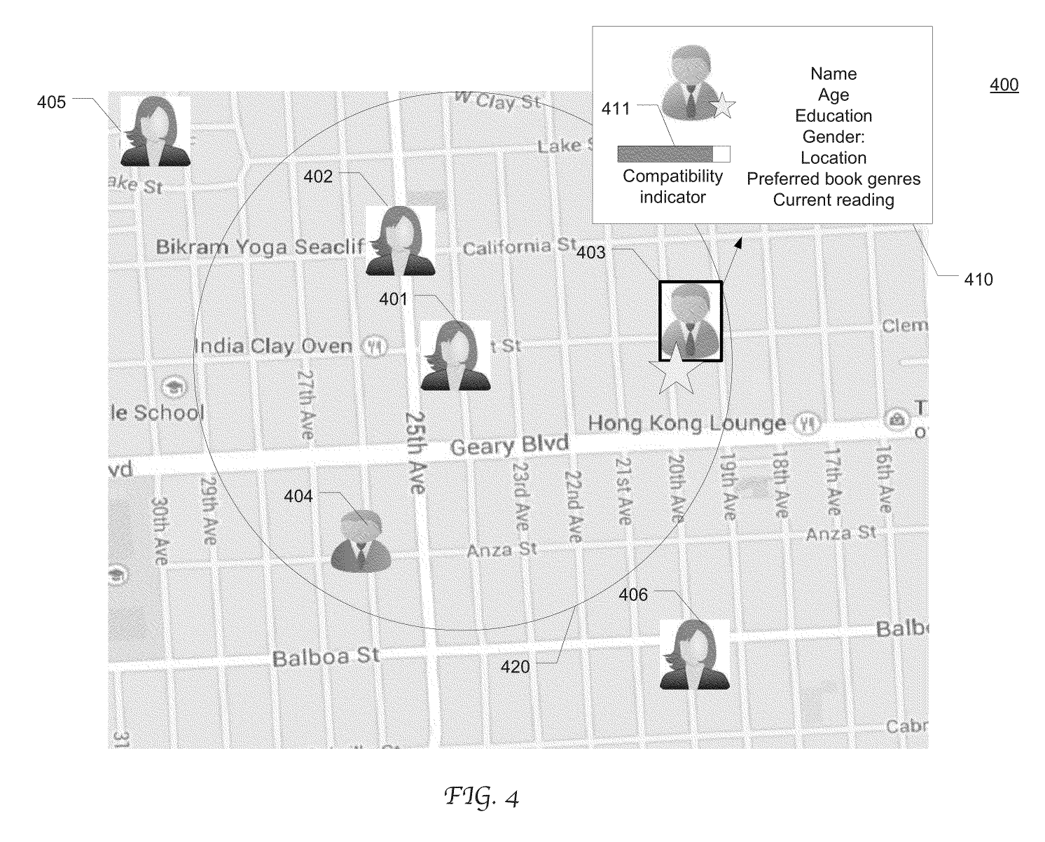

FIG. 4 is an exemplary on-screen GUI window 400 configured to present the discovery results on a requesting device in accordance with an embodiment of the present disclosure. In this example, the requesting user 401 specifies a certain distance in a discovery request. The search results include compatible readers (represented by clickable objects 402-404) located within the specified distance and compatible readers (represented by clickable objects 405-406) located outside but proximate to the specified distance. Clickable objects 401-406 showing photos of the requesting and compatible readers placed on the geographical map to visually indicate their locations. The circle 420 marks the border of the specified range for search. In some embodiments, each clickable object provides additional information about the reader, e.g., the identification, compatibility, and/or a current reading.

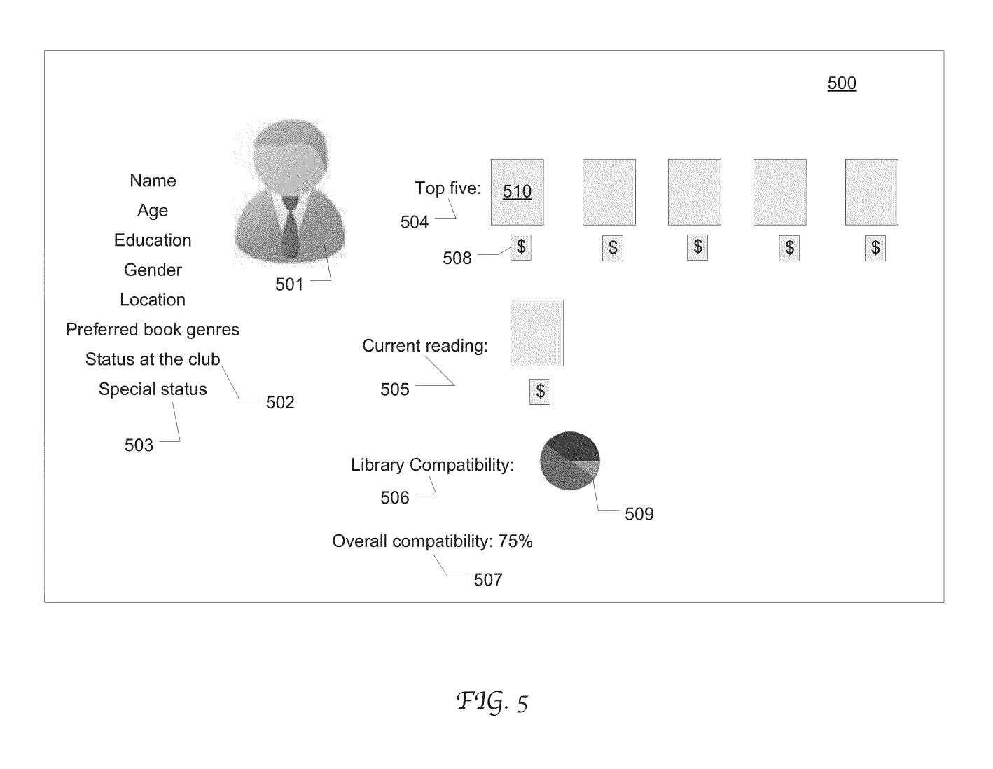

As illustrated, upon the requesting reader interacting with the clickable object 403, an overlay window 410 is rendered to display additional information on the selected reader. The pop-up window 410 includes information on biography, preferred book genres, and a current reading. The bar object 411 represents a compatibility indicator indicating the level of comprehensive compatibility derived from the information included in the personal profiles. If the requesting reader is interested in viewing further more information, a full view of a personal profile can be provided as shown in FIG. 5.

FIG. 5 is another exemplary on-screen GUI window 500 configured to present a personal profile of a compatible reader in accordance with an embodiment of the present disclosure. The personal profile includes a photo 501 of the compatible reader, the identification, age, education, gender, location, and preferred book genres. A reading social network may classify their members based on the number of books they read or purchased, or any other type of contribution. The classification of a reader can be indicated in the “Status at the club” field 502. The “Special status” field 503 can be used to label the status of being an author, an editor, a top contributor to a book club, etc.

The “Top five” field shows the book covers (e.g., 510) of the top favorite books, and the “Current reading” field shows the current reading of the reader. Each book presented is accompanied with a price, e.g., 508. Each book cover icon (e.g. 510) is embedded with a hyperlink directing to a purchase transaction website (e.g., hosted by an on-line book store) where the requesting reader can purchase and download the book. The book store may reward the reader for each purchase transaction initiated from his or her personal profile page. The reward may be in the form of purchase credit or cash credit for instant.

The “Library compatibility” field uses a pie chart 509 show the composition of a compatible reader's library, providing a perception into the compatible reader's reading preferences. Each segment in the chart may represent a book genre. The “overall compatibility” shows a normalized comprehensive compatibility score.

It will be appreciated that any other type of information useful for influencing a requesting reader's decision for networking with a particular reader can be included in the GUI window 500. The geosocial application program may render a GUI allowing a reader to create and edit such a personal profile and then submit to an intended server. The geosocial network management program may also render a webpage through which an authenticated reader can create and edit his or her personal profile. The various fields may be configured as mandatory or optional user input.

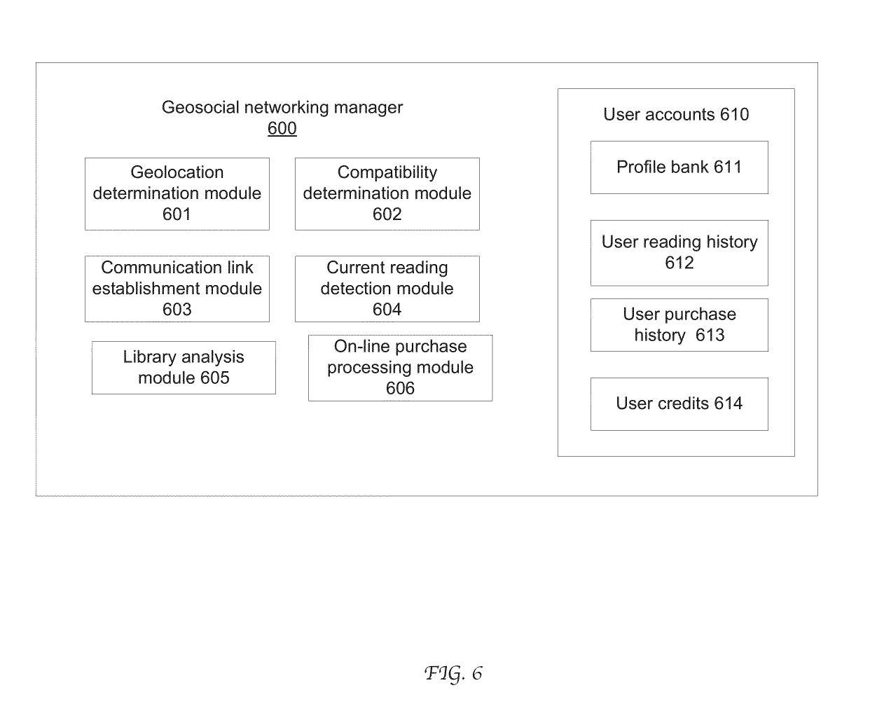

FIG. 6 is a function block diagram showing the components of a geosocial networking manager program 600 in accordance with an embodiment of the present disclosure. Program 600 may reside in a server device (e.g., 110 in FIG. 1) hosted by an on-line book store. As illustrated, the manager program 600 includes a geolocation determination module 601, a compatibility determination module 602, a communication establishment module 603, a current reading detection module 604, a library analysis module 605, an on-line purchase processing module 606 and a database of user accounts 610.

The geolocation determination module 601 can determine the geolocations of the readers based on the GPS coordinates of their associated electronic reading devices. Alternatively, a reader′ registered location as stored in the user account database 610 may be used directly as his or her current geolocation, for example if no GPS signals are available.

The compatibility determination module 602 can access and process the profiles between a requesting reader and another reader, and thereby determine compatibility thereof. For example, similarity scores of each attribute in the personal profile as well as a comprehensive compatibility index can be computed in this module.

The library analysis module 602 can extract relevant information from an eligible reader's library and/or reading history through any number of well known data-mining processes for compatibility determination. The library and/or reading history may be accessed from a storage device of the reader's reading device, or from the database 610. The information may include book genres, authors, subject matters, publishing time of the books in the library and the purchase record.

The communication establishment module 604 can establish a communication link between a requesting reader and a selected compatible reader, such as through instant messages, a web-phone call, a video chat, etc.

The on-line purchase processing module 606 can render a webpage through which a reader can complete a purchase transaction on a book. If the purchase transaction stems from a visit to a compatible reader's personal profile, a credit is issued to the compatible reader's account.

The user accounts database 610 includes a set of information for each registered reader. The database 610 has sections of a profile bank 611, user reading history 612, user purchase history 613, and user credits 614. The personal profile bank 611 stores the book reading personal profiles of the registered users. The user reading history 612 tracks the reading activities of each reader. The user purchase history stores the book purchase and downloading activities of each reader. The user credit bank 614 keeps a record of the credits issued to each reader based on the purchase transactions stemming from his or her personal profile. Depending on the privacy setting of an individual user account or personal profile, information included in the personal profile may be discoverable, in whole or in part, by a search engine.

It will be appreciated that the function modules in FIG. 6 and the components thereof can be implemented in respective suitable methods and processes that are well known in the art. Program 600 may have various components configured to perform other functions that are well known in the art.

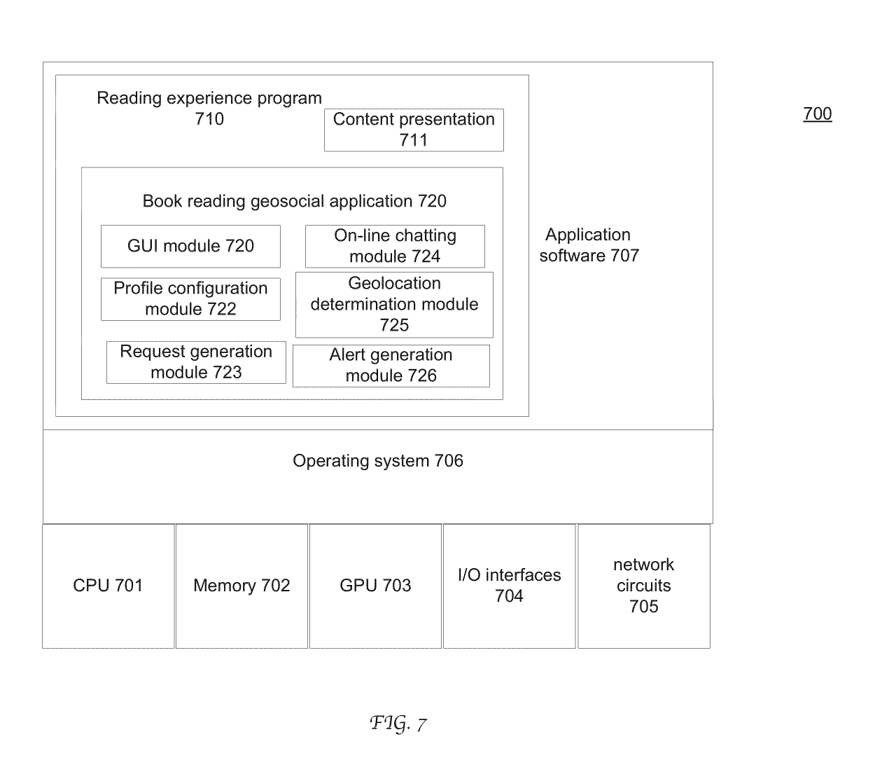

FIG. 7 is a block diagram illustrating an exemplary electronic reading device 700 installed with a reading experience program 710 having book reading geolocation networking software in accordance with an embodiment of the present disclosure. The device 700 comprises a processor 701, system memory 702, a GPU 703, I/O interfaces 704, network circuits 705, an operating system 706 and application software 707 including the reading experience program 710 stored in the memory 702. In the illustrated example, the reading device 700 is coupled to a server through a communication channel, as described in greater detail with reference to FIG. 1.

In the illustrated example, the reading experience program 710 comprises a book content presentation module 711 and the book reading geosocial application 720. When incorporating configuration input and personalized input and executed by the CPU 701, the reading experience program 710 can present book content through the book content presentation module 711. In some other embodiments, the book reading geolocation networking application may be implemented as a separate program or as an integral part of another type of programs.

The book reading geosocial application 720 allows a reader to conveniently discover a compatible reader within a specified geographical area. The application 720 includes a GUI module 712, a profile configuration module 722, a request generation module 723, an on-line chatting module 724, and an alert generation module 725. The GUI module 712 can render one or more GUI windows configured to receive user input to configure and edit personal profiles, present information on discovered compatible readers (e.g., FIG. 4 and FIG. 5), and display messages sent by another reader (e.g., a requesting reader), etc.

The profile configuration module 722 may have a profile template based on which a reader can create and edit a personal profile. A reader is allowed to set the personal profile as private and non-discoverable by other readers. Based on the reader's configuration, a personal profile can be published with selected fields of information, while other fields remain inaccessible to public.

The request generation module 723 may generate discovery requests for discovering compatible readers and communication requests for contacting another reader. A discovery request can be generated automatically based on a reader's configuration or upon a reader instruction, as described above. In some embodiments, pursuant to the hosting entity's policy, a reader can only send a limited number of requests within a period of time, e.g., 5 requests a day. The request generation module 723 can keep track of the requesting activities of the reader and impose such a policy constraint. The maximum number of requests allowed may vary with the statuses of the readers within the reading community. For instance, readers with a long affiliation history with the community, readers effectively promoted book sales, authors, and editors are allowed to send more requests than general readers.

The on-line chatting module 724 can render a communication interface upon receiving the requesting reader's request for contacting a selected compatible reader. For example, the communication interface allows reader to communicate by live text messages, voice mails, emails, video clips, and etc.

The alert generation module 725 can generate indicia, e.g., an on-screen indicia or an emission of sound, to inform the instant reader of various events related to compatible reader discoveries. For example, if the instant reader associated with the device 700 is being discovered as a compatible reader of another reader, an on-screen indicia may be rendered.

The reading experience program 710, more specifically the book reading geosocial application, may perform various other functions as discussed in detail with reference to FIG. 1-FIG. 5. As will be appreciated by those with ordinary skill in the art, the reading experience program 710 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method comprising:
rendering an on-screen graphical user interface (GUI) for display on a display device coupled to a first computing device, wherein said on-screen GUI is configured to present content of electronic books;
receiving user input via said on-screen GUI to configure a first personal profile of a user of said first computing device, wherein said first personal profile identifies a first selection of books;
sending indications representing a first geolocation of said first computing device to a server;
sending a request to a server for discovering compatible readers within a distance from said first geolocation;
receiving personal profiles of discovered compatible readers from said server, wherein each personal profile comprises a respective selection of books associated with a corresponding discovered compatible reader, wherein said discovered compatible readers are discovered based on geolocations of computing devices associated with said discovered compatible readers and further based on and relatedness between said first selection of books and respective selections of books of said discovered compatible readers;
receiving said geolocations of said computing devices from said server; and
displaying a plurality of visual objects on said on-screen GUI, wherein said plurality of visual objects represent said discovered compatible readers.

2. The computer implemented method of claim 1, wherein said user and said discovered compatible readers are registered members of a book reading community that hosts said server.

3. The computer implemented method of claim 1, wherein said on-screen GUI is configured to:
receive a user interaction with a visual object of said plurality of visual objects, wherein said visual object represents a first discovered compatible reader;
display a personal profile of said first discovered compatible reader, wherein said personal profile comprises a photo and identifications of a second selection of books, book genres and authors preferred by said first discovered compatible reader; and
display a plurality of clickable objects associated with said second selection of books respectively, wherein a user interaction with a clickable object by said user is operable to open a webpage configured to facilitate an on-line purchase transaction of a corresponding book.

4. The computer implemented method of claim 3, wherein said first selection of books comprises a book currently being read on said first computing device, and wherein further said second selection of books comprises a book currently being read on a computing device used by said first discovered compatible readers.

5. The computer implemented method of claim 1 further comprising: receiving compatibility scores of said discovered compatible readers from said server, wherein each compatibility score is determined by comparing said first personal profile and a corresponding personal profile of a respective discovered compatible reader, and wherein said on-screen GUI is configured to present said compatibility scores.

6. The computer implemented method of claim 1 further comprising: accessing a library of books stored in said computer device; automatically generating said first selection of books based on said library; and automatically sending said first personal profile to said server.

7. The computer implemented method of claim 3 further comprising:
sending a communication request for real-time communication with said first discovered compatible reader; and
rendering an on-line chat interface on said display device of said first computing device, wherein said on-screen chat interface is configured to display messages exchanged between said user and said first discovered compatible reader.

8. The computer implemented method of claim 1, wherein said indications are generated by a global positioning system (GPS) installed within said first computing device.

9. The computer implemented method of claim 1 further comprising:
receiving a communication request initiated from another computing device, said communication request being forwarded by said server; and
displaying an on-line chat interface on said GUI of said display device of said first computing device responsive to said communication request.

10. A computer implemented method comprising:
receiving a discovery request sent from a requesting device via a communication network, wherein said requesting device is associated with a requesting user;
determining a geolocation of said requesting device;
locating a set of computing devices associated with eligible users that are located within a distance from said geolocation;
comparing a personal profile of said requesting user and a personal profile of said eligible users of said set of computing devices, wherein each of said personal profiles comprises reading preferences of a corresponding user;
selecting compatible users from said eligible users based on said comparing;
sending information on said compatible users to said requesting device, wherein said information comprises identities, personal profiles, compatible scores and geolocations.

11. The computer implemented method of claim 10 further comprising:
receiving a communication request from said requesting device to communicate with a selected compatible user on-line; and
forwarding said communication request to a computing device associated with said selected compatible user.

12. The computer implemented method of claim 11 further comprising:
receiving a purchase request from said requesting user to purchase a book identified in a personal profile of said selected compatible user;
rendering a webpage for display on said requesting device, wherein said webpage is configured to facilitate an on-line purchase transaction of said book;
accrediting said selected compatible user for said on-line purchase transaction.

13. The computer implemented method of claim 10 further comprising exchanging instant messages between said requesting user and said selected compatible user.

14. The computer implemented method of claim 10, wherein each of said personal profile comprises a plurality of fields, wherein each field is assigned with a weight factor, and wherein further said plurality of fields comprise a current reading field.

15. The computer implemented method of claim 14, wherein said comparing comprises calculating a compatibility score between a personal profile of a requesting user and a personal profiles of an eligible user based on values of said plurality of fields and weight factors thereof.

16. The computer implemented method of claim 15 further comprising:
responsive to said discovery request, automatically detecting books that are being read on said requesting device and on said computing devices;
determining similarities between a book being read on said requesting device and a book being read on a computing device associated with said eligible user; and
incorporating said similarities in said calculating said compatible score.

17. A system comprising:
a bus;
a processor coupled to said bus;
memory coupled to said processor via said bus and comprising instructions that, when executed by said processor, cause the system to perform a method of facilitating geosocial networking among book readers, said method comprising:
rendering an on-screen graphical user interface (GUI) for display on a display device coupled to a first computing device, said first computing device being associated with a first personal profile of a user of said first computing device, wherein said first personal profile identifies a first selection of books;
sending a request to a server for discovering compatible readers within a distance from a first geolocation of said computing device;
receiving personal profiles of discovered compatible readers from said server, wherein each personal profile comprises a respective selection of books associated with a corresponding discovered compatible reader, wherein said discovered compatible readers are discovered based on geolocations of computing devices associated with said discovered compatible readers and further based on relatedness between said first selection of books and said selections of books associated with said discovered compatible readers;
receiving said geolocations of discovered compatible readers from said server; and
displaying a plurality of visual objects on said on-screen GUI, wherein said plurality of visual objects represent said discovered compatible readers.

18. The system of claim 17, wherein said on-screen GUI is configured to:
receive a user interaction with a visual object of said plurality of visual objects, wherein said visual object represents a first discovered compatible reader;
display a personal profile of said first discovered compatible reader, wherein said personal profile comprises a photo and identifications of a second selection of books, book genres and authors preferred by said first discovered compatible reader; and
display a plurality of clickable objects associated with said second selection of books respectively, wherein a user interaction with a clickable object is operable to open a webpage configured to facilitate an on-line purchase transaction of a corresponding book.

19. The system of claim 18, wherein said first selection of books comprises a book currently being read on said first computing device, and wherein further said second selection of books comprises a book currently being read on a computing device used by said first discovered compatible readers.

20. The system of claim 18 further comprising:
sending a communication request for real-time communication with said first discovered compatible reader; and
rendering an on-line chat interface on said display device, wherein said on-screen chat interface is configured to display messages exchanged between said user and said first discovered compatible reader.
